(19) United States
(12) Patent Application Publication
(10) Pub. No.: US 2013/0187485 A1
(43) Pub. Date: Jul. 25, 2013

(54) ROTARING ELECTRICAL MACHINE

(71) Applicant: NIPPON PISTON RING CO., LTD., Saitama-shi (JP)

(72) Inventors: Masafumi SAKAMOTO, Saitama-shi (JP); Shigeyoshi SATO, Saitama-shi (JP); Shunsuke TAKEGUCHI, Saitama-shi (JP)

(73) Assignee: NIPPON PISTON RING CO., LTD., Saitama-shi (JP)

(21) Appl. No.: 13/705,737

(22) Filed: Dec. 5, 2012

(30) Foreign Application Priority Data
Dec. 6, 2011 (JP) 2011-266760

(51) Int. Cl. H02K 1/26; H02K 1/02

(52) U.S. Cl. CPC H02K 1/265; H02K 1/02
USPC 310/43; 310/44

(57) ABSTRACT

In a rotating electrical machine of radial-gap type, a radial core, having number of winding slots of “m”, is constructed as an integral compacting type by compacted powder or as a split compacting type with compacted powder. The radial core has a thickness in an axial direction of winding thereof so as to become thinner toward outward from a central portion thereof, in which the “m” is integer number in a range of 4 to 12.

### BACKGROUND OF THE INVENTION

1. Field of the Invention

The present invention relates to a rotating electrical machine such as electric motor, electric generator or like.

2. Background Technology

Conventionally, commercial market requires for a rotating electrical machine such as electric motor or electric generator to be thin and compact in size or structure, and particularly, in these days, as a countermeasure to global warming tendency, requirement for energy saving and high efficiency has been increased. Moreover, it has been further strongly required for the rotating electrical machine to have low vibration and low noise as well as cheap cost. As related conventional technology, the following Patent Document will be listed up.

### PRIOR ART DOCUMENT

### Patent Document

[Patent Document 1] Japanese Patent Laid-open Publication No. 2007-336732.

### DESCRIPTION OF THE INVENTION

### Problems to be Solved by the Invention

In a conventional technology related to a general radial-gap type rotating electrical machine including a brushless DC rotating electrical machine (called hereinafter “BLDC rotating electrical machine”) and a switched reluctance rotating electrical machine (called hereinafter “SR rotating electrical machine”), a stator core is composed of laminated silicon steel plates, and in addition, in a case when cost reduction and efficiency are weighed, a concentrated winding method or manner has been adopted. This is based on a reason in which even if a distributed winding method or manner is adopted, a coil end portion that does not contribute to torque generation becomes large, and copper loss is increased, leading to lowering in efficiency, and a reason in which in the concentrated winding method, the winding becomes simple and it becomes possible to directly wind the windings, leading to cost reduction for manufacture. In the concentrated winding method, when constructed practically, the number of slots of the stator is 4 to 12.

In addition, even in the concentrated winding method, the coil end has a height of a coil end portion smaller than that of the distributed winding method, but in order to increase efficiency, copper loss will be increased, thus providing a problem. In order to obviate such problem, there has been proposed one countermeasure in which winding pole shape of the stator is formed so as to protrude in an axial direction or circumferential direction in rotation, which is so-called as overhang shape or structure, thus forming a dust core formed of compacted powder. The dust core is formed in a manner such that a small amount of resin is coated to a soft magnetic iron powder as a binder, and mixed for the purpose of insulating eddy current, and sintered after the compression compacting.

Although the silicon steel plate lamination method provides a simple two-dimensional shape, in the above method it is possible to adopt a three-dimensional complicated shape, and in addition, eddy current loss as a part of copper loss becomes small, being advantageous.

Further, although the dust core mentioned above has a defect of having magnetic flux less than that of silicone steel plate, it is applicable for realizing high efficiency because of increased opposing area to a rotor. Moreover, in order to achieve high efficiency, it is necessary to increase winding space factor. In this regard, in a direct winding method to a slot in the concentrated winding method, since copper wire is wound up through a slot opening, the winding space factor is merely about 20 to 30%. In the present invention, it is aimed to disclose an integrated type compacting structure of a core which leads to improvement in the winding space factor, which has been considered to be impossible in a lamination method, by utilizing advantage capable of providing three-dimensional complicated structure by the dust core.

Furthermore, for the slot opening, it is necessary to have 2 to 3 mm even for a copper wire having diameter of 0.5 mm, which may depends on wire diameter in viewpoint of wire insertion. Then, there has been provided a split core usage method as means for remarkably increasing the winding space factor and for making small the slot opening.

In the split core method, because wire winding working is made in a state of the split core, the winding space factor more than 50% may be realized. Furthermore, in the split core method, the slot opening portion can be made further smaller to about 0.5 mm, for example. This can provide effect of reducing cogging torque in a permanent magnet type rotating electrical machine. This will be understood from the fact that, even in the permanent magnet type rotating electrical machine, the cogging torque is appropriately zero in a slot-less rotating electrical machine. In the case of the split type core, assay of split piece is needed. Concerning the assay of the split core, conventional technology disclosed in the above-mentioned prior art document (Patent Document 1) will be listed up.

### SUMMARY OF THE INVENTION

The present invention was made in consideration of the circumstances described above and an object thereof is to provide a rotating electrical machine capable of further increasing the winding space factor by solving the defect encountered in the prior art such as disclosed in the Patent Document 1.

The above and other objects can be achieved by the following means as aspect and embodiment of the present invention.

[Means 1] There is provided a rotating electrical machine of radial-gap type in which a radial core, having number of winding slots of “m”, is constructed as an integral compacting type by compacted powder or as a split compacting type with a compacted powder, wherein the radial core has a thickness in an axial direction of winding portion thereof in a manner to become thinner toward outward from a central portion thereof, in which the “m” is integer number in a range of 4 to 12 (not less than 4 and not more than 12).

[Means 2] In the rotating electrical machine according to the above means 1, the radial core has an overhang portion in a rotating shaft direction and/or rotational circumferential direction.

[Means 3] In the rotating electrical machine according to the above means 1 or 2, when the radial core is joined and fixed after winding of the radial core, the “m” junction portions are subjected to either one of welding process, adhesion process or resin molding process, or combination thereof.

[Means 4] In the rotating electrical machine according to the above means 1 or 2, the compacted powder forming the radial core is subjected to at least one of resin coating treatment and resin impregnation treatment, or both the treatments.

[Means 5] In the rotating electrical machine according to the above means 1 or 2, the rotating electrical machine is an inverted rotor type rotating electrical machine, in which when the winding is wound around the radial core and then integrated and fixed, a cylindrical member is inserted into the integrated radial core and fitted to an inner periphery of the integrated radial core in a manner of providing a concentric structure.

[Means 6] There is also provided a rotating electrical machine of radial-gap inner rotor type in which a radial core, having number of winding slots of “m”, is constructed as an integral compacting type by compacted powder or as a split compacting type with compacted powder, wherein a portion concentrically protruding in an axial direction in a side view of the radial core as a concentric guide for ensuring an air gap between the stator and a rotor, and the protruded portion is engaged with front and back brackets, in which the “m” is integer number in a range of 4 to 12 (not less than 4 and not more than 12).

[Means 7] In the rotating electrical machine according to the above means 6, the radial core has a thickness in an axial direction of the winding portion so as to become thinner toward outward from a central portion thereof.

[Means 8] In the rotating electrical machine according to the above means 6, the radial core is provided with a groove or a hole at outer peripheral portion of the central portion thereof, and the radial core is fixed to the brackets by interposing metal material other than compacted powder in the groove or hole.

[Means 9] In the rotating electrical machine according to the above means 6, when the radial core is constructed by “m” split compacting and the radial core is integrated with and fixed to the winding after the winding process, a junction portion of an outer peripheral portion at the integrating process is coupled by means of welding.

[Means 10] In the rotating electrical machine according to the above means 6, the compacted powder forming the radial core is subjected to at least one of resin coating treatment and resin impregnation treatment, or both the treatments.

### Effects of the Invention

1) Since the core winding portion becomes thinner, in an axial thickness, according to largeness of diameter thereof, the thickness of the winding portion after the winding process at the coil end portion becomes uniform in the radial direction, thus increasing the number of windings, and hence, improving the space factor of the winding. In addition, when the split core is wound in a state of one piece, the space factor of the winding can be further improved, and accordingly, high torque and high efficiency can be realized. Further, it is desirable for the space factor of the winding to be in a range of 40 to 60%.

2) When the press-compacting process of the dust core is performed, a component in a tangential direction of the pressed force component is generated in a winding groove, and density at the central portion of the rotating machine core can be enhanced. Because of this reason, in the inner rotor type, magnetic resistance at stator teeth portion opposing to the rotor can be decreased, thus being effective.

3) Since the slot opening portion can be made extremely minimum, cogging torque can be made extremely minimum, leading to reduced vibration and noise.

4) Since the opposing area to the rotor is increased in the overhang structure of the dust core in comparison with a lamination method, high torque and high efficiency can be expected.

5) By the provision of the dust core, eddy current loss approaches zero, and especially, iron loss becomes less at high speed operation, thus providing a rotating electrical machine with high efficiency.

6) Since the integration of the split core is performed by means of welding, the working becomes easy and the core provides rigidity, and in addition, the magnetic resistance at the junction portion can be reduced, thus providing a rotating electrical machine having high performance with reduced manufacturing cost.

7) In a case where the integration of the split core is performed by means of resin mold, since the welding and cylindrical member can be utilized together, thus providing a rotating electrical machine having high rigidity and reliability.

8) In the structure of the inner rotor type, since the side surface is utilized as a guide without using the outer diameter portion of the core as front and back brackets, it becomes possible to provide a rotating electrical machine having compact and thin structure. Further, in a case when the groove formed to the core outer peripheral portion is utilized for the fastening of both the brackets, the structure is further made compact.

9) It is necessary for the surface pressure to the dust core to be about 800 MPa, and in order to manufacture an iron core having large diameter, it is required to prepare a pressing machine having large power corresponding to projection area thereof, requiring an expensive equipment cost. However, in the use of the split core into “m” pieces provides a projection area of 1/m, thus reducing a cost for preparing an equipment for pressing.

10) The dust core is easily separated into iron powder and copper wire, thus being excellent in re-cycle use.

11) Since the use of the compacted powder is excellent for providing three-dimensional shape, leading to improved cost performance.

### BRIEF DESCRIPTION OF THE DRAWINGS

FIG. 1 is a view illustrating an interior of a split core rotating electrical machine according to the present invention viewed in an axial direction thereof.

FIG. 2 is a sectional side view taken along the line II-II in FIG. 1.

FIG. 3 is a view illustrating an interior of an inverted rotor type split core rotating electrical machine according to the present invention viewed in an axial direction thereof.

FIG. 4 is a sectional side view taken along the line IV-IV in FIG. 3.

FIG. 5 is a view illustrating an interior of another split core rotating electrical machine according to the present invention viewed in an axial direction thereof.

FIG. 6 is a sectional side view taken along the line VI-VI in FIG. 5 provided with front and rear side brackets.

FIG. 7 is a view, corresponding to FIG. 2, in which a case is provided.

FIG. 8 is a view for explaining a conventional technology.

### DESCRIPTION OF THE PREFERRED EMBODIMENT

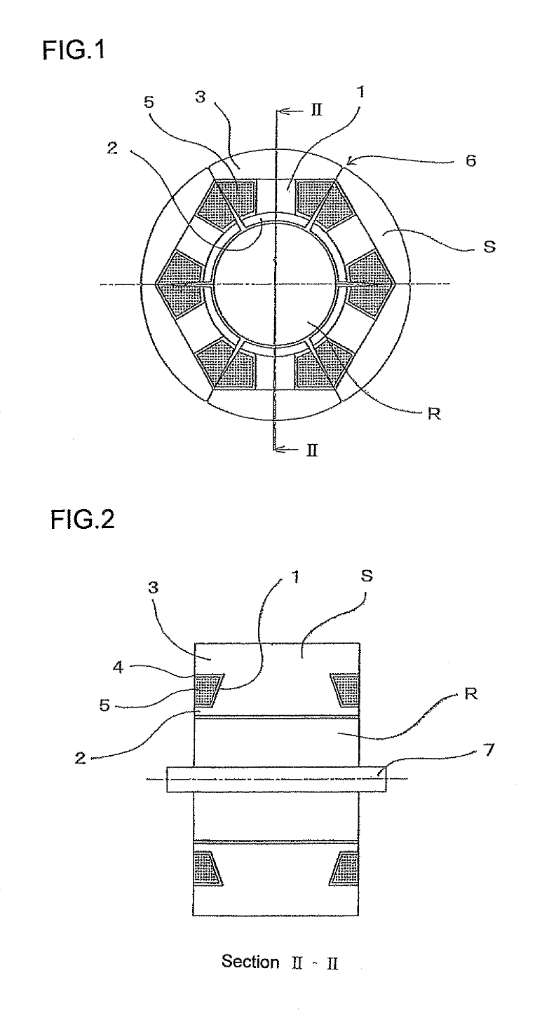

FIG. 1 shows a structure or configuration of one example according to an embodiment of the present invention, in which an interior of a split core rotating electrical machine viewed in an axial direction thereof is shown. In FIG. 1, however, only a stator S and a rotor R are shown, and a bracket, a bearing and the like are eliminated from illustration.

It is to be noted that, herein, a radial core compacted from compacted powder may be described as dust core, and a split compacted radial core may be described as split core. Furthermore, a structure in combination of an insulator and a winding sectional area may be described as taper winding groove. Further, winding sectional surface portions 5, 15 and 25 are shown in sections in FIGS. 1, 3 and 5, respectively.

A stator 3 has a three-phase six-winding pole structure, in which six winding poles are radially arranged evenly at an interval of 60 degrees. The number of the slot of the stator is six which accords with the number of the winding poles. FIG. 1 represents a case of six split cores by the dust core in which winding is wound up in a groove formed to the core, which is so-called overhang structure. In the overhang structure, since a coil end does not protrude outward from a core surface, an area opposing to a rotor increases in a thin or same rotating electrical machine size, and hence, high torque can be provided.

FIG. 2 is a sectional view taken along the line II-II in FIG. 1 of a plane including a rotating axis of the rotating electrical machine shown in FIG. 1. With reference to FIGS. 1 and 2, reference numeral 1 denotes a taper winding groove(s) provided for the core, and each of the grooves 1 is tapered more largely toward an outward direction in diameter of the rotating electrical machine. In other words, the thickness in the axial direction of each of the six cores becomes thinner toward the outward from the central portion of the winding portion. The reason of such structure will be explained hereunder.

FIG. 1 is a view in which the winding is wound up fully in winding spaces, and a finished outer circumferential width of the winding becomes larger toward the outward in the radial direction thereof. This is because the six winding poles are distributed radially. According to such structure or arrangement, the height of the coil end becomes larger toward the outward in the radial direction when the winding is fully wound in the winding space. In such structure, the coil end height becomes uneven and becomes larger, so that the thinner structure cannot be expected.

Against the above arrangement, according to the present invention, since the groove is tapered largely toward the outward direction in the diameter, such a defect as mentioned above can be solved.

With the six-winding pole structure, 60-degree of taper is desired, and in general, with “m”-winding pole structure, 180 degrees/m may be desired. The present invention is not limited to such six-winding pole structure, and in a practical use, four-, eight- and twelve-winding poles for two-phase structure are desirable; six-, nine- and twelve-winding poles for three-phase structure are desirable; and five- and ten-winding poles for five-phase structure are desirable. The reason why such number of winding poles are desirable resides in that in a case of more than fifteen-winding poles over twelve-winding poles, the split core provides complicated structure and damages in manufacturing cost. In consideration of the above matters, it is desired that the number “m” is not less than four and not more than 12, i.e., in a range of 4-12. It is herein to be noted that the m-pole machine is the same as a rotating electrical machine having “m” number of slots.

In FIGS. 1 and 2, reference numeral 2 denotes an overhang portion, reference numeral 3 also denotes an overhang portion of a back yoke, reference numeral 4 is an insulator made of resin, reference numeral 5 is a sectional portion of the winding, reference numeral 6 denotes a core junction portion of the split core which is to be welded with reference to an inner diameter portion, and reference numeral 7 denotes a rotating shaft.

The rotor R constitutes a brushless DC rotating electric machine by using a permanent magnet. The six-winding poles utilizes a rotor and magnetized four poles of N, S, N, S, and in the rotor R, the permanent magnet may be substituted with one having four teeth by silicon steel plate of magnetic iron and dust core, which so-called constitutes an SR rotting electric machine, i.e., switched reluctance rotating electric machine.

In FIG. 1, although a radial-gear type inner rotor split core is shown, the present invention is applicable to an integrated type core which is not split and in which the winding poles are more than four (4) and less than twelve (12). The integrated type core is one provided with no seam in the structure which is shown as reference numeral 6 in FIG. 1. The present invention is further effective even if provided with no overhang portion. A break of the winding can be prevented by a resin insulator. However, a case of no overhang portion is disadvantageous for achieving thin structure and high torque.

Furthermore, in a case where the “m” (number) split cores are combined and secured after the winding, a core rod is inserted into the stator inner diameter portion and the “m” (number) jointed portions are welded to the portion shown with the reference numeral 6 in FIG. 1, a stator having strong and cheap can be obtained. Although the welding process is desirable, adhesion may be applied, and a resin molding method and their combined process may be adopted.

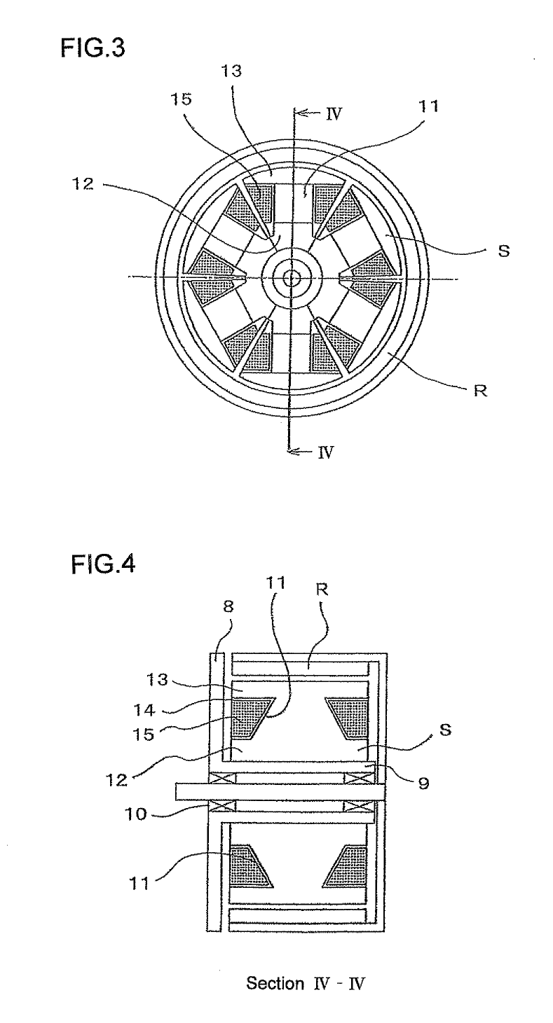

FIG. 3 is a view showing a case in which the present invention is applied to the “m” (number) split cores utilizing the radial gap-type inverted rotor winding poles.

FIG. 4 is a sectional view taken along the line IV-IV in FIG. 3, in which the rotating shaft 7 is included. In FIG. 4, reference numeral 8 is a flanged portion, and reference numeral 9 is a metal cylindrical member, in which, while coupling the split core, a deviation between the axes of the coaxial stator S and the rotor R can be avoided. Reference numeral 10 denotes a bearing. In this structure, the thickness of the tapered winding groove 11 is made reduced toward the outward in the radial direction thereof by the same reason as that mentioned with respect to the inner rotor.

Reference numeral 12 is an overhang portion, reference numeral 13 is an overhang portion of the back yoke, reference numeral 14 is an insulator made of resin, and reference numeral 15 shows a sectional surface area of the winding 15. In this structure, as like as the case of the inner rotor type mentioned hereinbefore, an integrated core may be utilized without the “m” (number) winding poles are not split. In the case where the rotor R is a permanent magnet, an SR rotating electric machine will be constituted by providing magnetic iron teeth to a brushless DC rotating electric machine.

Furthermore, with the structure shown in FIG. 4, if the rotor R is fixed, the stator S is rotatable, and a commentator is mounted, and the commutation is performed, it is applicable as a DC rotating electric machine with a brush. Accordingly, the present invention will be applicable to a DC rotating electric machine.

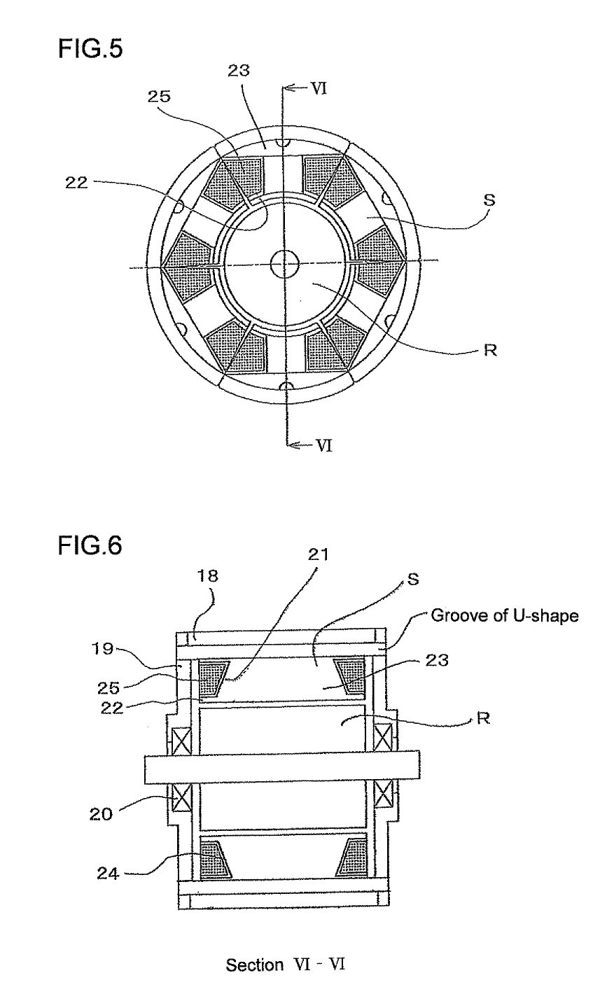

FIG. 5 represents a radial gap type inner rotor rotating electric machine such as one of an integrated compacting type in which rotting machine core is formed of compacted powder of the winding slot number is “m”, or one constituted by “m” (number) split cores, in which the number “m” is six (6). In FIG. 5, reference character S is stator and R is rotor. Reference numeral 22 is an overhang portion opposing to the rotor, reference numeral 23 an overhang portion of the stator, and reference numeral 25 denotes a section of the winding.

FIG. 6 is a sectional view taken along the line VI-VI in FIG. 5 which is provided with a rotating shaft. In FIG. 6, reference numeral 6 is a bearing rotatably supporting the rotor R, and reference numeral 21 is an insulator.

In the rotating electrical machine of FIGS. 5 and 6, by utilizing merit of the compacted powder which can be formed into three-dimensional complicated structure, and in order to ensure an air gap between the stator and the rotor, there is provided a portion 18 protruded concentrically in a side axial direction of the core as concentric guide, and front and back brackets 19 are fitted therewith, which is the characteristic feature of this embodiment shown in FIGS. 5 and 6.

The protruded portion 18 may be formed slightly inside in the diameter direction than the position shown in FIG. 6 so as to guide the outer peripheral portion of the protruded portion 18 along the inner peripheral portion of the bracket 19 to be thereby fitted and engaged therewith. Otherwise, the overhang portion 22 shown in FIG. 6 may be formed in a more protruded manner in the axial direction by a length required to be thereby engaged with the bracket 19. This method will be adopted in the structure of the taper winding groove, the flat winding groove, or winding groove formed with no overhang portion as long as the dust core be adopted.

Further, in a case where the split core is welded at a portion to be welded of the outer peripheral portion, the welded portion is mounted. However, since the outer peripheral portion is not utilized for guiding the protruded portion, no problem will be caused. By using this method, since the peripheral portion of the core is not covered with the front and back brackets, a small-sized rotating electric machine having small diameter may be provided, and in addition, by using the tapered winding groove type overhang core of the present invention, the coil end is made flat, thus providing a thin rotating electrical machine such as shown in FIG. 6.

Further, it is desirable to penetrate a bolt into a groove having U-shape, for example, formed to the pouter peripheral portion of the center of the radial core of the stator shown in FIGS. 5 and 6 to thereby fix both the right and left brackets together, and according to such structure, the outer diameter of the rotating electrical machine is not made large, thus being desirable. Otherwise, screw-fastening stress to be applied to the core portion can be resolved by inserting a bar made of an aluminum material or iron material having a length slightly longer than the axial length of the core into the core groove of U-shape, for example, and fastening, by means of screws or like, both the end portions of the bar and the front and back brackets together. Further, although the outer diameter of the rotating electrical machine may become large, these bars may be integrally provided inside the cylindrical member made of aluminum material or like formed to the core outer peripheral portion. Otherwise, it may be possible to provide any bar to the cylindrical member, and in such case, the right and left brackets are fastened together with the bolt passing through the core groove so as to receive the fastening stress by the cylindrical member. The above-mentioned groove may be substituted with a hole or like, but is formed as a hole, a portion near the outer periphery becomes thin, adversely leading to easy breaking, and thus, it is desirable to form as groove.

More preferably, in the split core type rotating electrical machine, as an inner rotor, in which the winding is performed to the winding pole having winding groove having thin thickness in the rotating axis direction of the dust core, and thereafter, “m” (number) cores are integrated, the portions to be welded of the outer peripheral portion at the joining process are welded to thereby join the dust cores together, and according to such process, since main strength of the stator can be ensured, the stator finished in the winding process can be realized.

Furthermore, since the dust cores are directly joined through the welding, there can be provided a rotating electrical machine capable of reducing the magnetic resistance at the joined portion, and in the manufacturing process, laser welding is preferred as the welding method because the laser welding can highly heat the pole portion for a short time period.

Further, other than the above-mentioned welding method, the “m” (number) junction portions can be joined by means of welding, adhesion, resin molding, or like means, or combination thereof. The term of adhesion may include adhesion through impregnation.

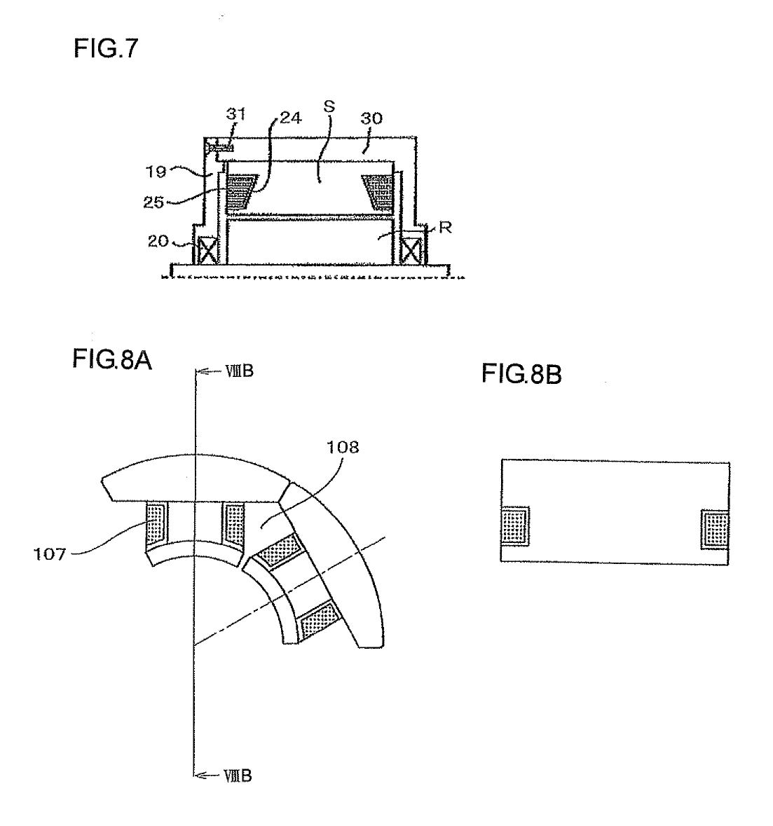

FIG. 7 shows an example of a rotating electrical machine in which the stator S is accommodated in a case 30, and after the insertion of the rotor R, the bracket is assembled. Thereafter, the case 30 and the bracket 19 are fastened by means of screw 31. In this example, although the outer diameter of the motor becomes larger by an amount corresponding to the thickness of the case in comparison of the structure shown in FIG. 6, any stress is not applied to the stator S, and hence, there can be realized a rotating electrical machine having high strength structure.

In this case, even in either one of the cases of the stator S being an integrally compacted core or a split compacted core, it is desirable that the stator S is welded or adhered to the case 30, or is sinter-fitted to be fixed thereto. In these cases, if the split compacted core is adopted, it is not always necessary to join or weld both junction portions of the split compacting core to each other. Further, as to the rotor R in these cases, various types mentioned hereinbefore may be applied.

In the embodiments of the rotating electrical machine according to the present invention, it is desirable for the dust core to be effected with resin coating or resin impregnation treatment, or both to improve strength and durability thereof. Here, any specific method or means for the above treatment is not limited, and various methods or means will be adopted as long as the method, in which the surface of the dust core is coated with resin or in which resin is impregnated into the interior of the dust core, is adopted. More specifically, electrodepositing method, electrostatic coating method, dipping method or the like may be adopted. Moreover, as to the resin to be used, the resin is not limited to specific one and various resins may be selectively used. Furthermore, in the case of the dipping method, dipping solution including a liquid type adhesive agent or vanish which is generally used may be used.

FIG. 8 is a view representing a conventional structure of a rotating electrical machine having, so-called, an overhang structure of a dust core with no tapered winding groove. Because of this reason, the sectional shape of the winding 107 as shown in FIG. 8A differs from that shown in FIG. 1. That is, in FIG. 8A, the winding sectional shape 107 is not a sector shape and a shape parallel with the winding core. As a result, there remains a space 108 which is not usable for the winding, whereas according to the present invention, such space 108 does not remain as shown in FIG. 1. Since the torque as the electric motor is proportional to the winding copper amount, i.e., in proportion to square root of an area of the sectional portion 107 in FIG. 8, the torque of the electric motor of the present invention becomes √2 times by making twice the winding copper amount of FIG. 1 with respect to that of FIG. 8.

Further, in a case of a generator, power generating amount will increase. FIG. 8B is a sectional view taken along the line VIIIB-VIIIB in FIG. 8A representing structure of a conventional winding groove.

Furthermore, in the structure shown in the Patent Document 1 disclosing the conventional technology, there is not provided with nor intimated any tapered groove structure, and accordingly, the winding space factor does not increase. In addition, an annular reinforcing ring is fixed or secured by means of rivet caulking or like for the reinforcing the coupling of the split core, but this means involves such defect as breakage or crack of dust core, or cost increasing, thus being disadvantageous. Against such defects, according to the welding method of the present invention, such defects and/or disadvantages can be eliminated.

As mentioned hereinbefore, the rotating electrical machine with the dust core of the present invention is applied as it is to an electric motor, electric generator or like and is capable of reducing manufacturing cost, providing rigid, compact and thin structure and performing high efficiency, thus being extremely suitable for practical use, and being expected in industrial contribution.

1. A rotating electrical machine of radial-gap type in which a radial core, having number of winding slots of “m”, is constructed as an integral compacting type by compacted powder or as a split compacting type with compacted powder, wherein the radial core has a thickness in an axial direction of winding portion thereof in a manner to become thinner toward outward from a central portion thereof, in which the “m” is integer number in a range of 4 to 12 (not less than 4 and not more than 12).

2. The rotating electrical machine according to claim 1, wherein the radial core has an overhang portion in a rotating shaft direction and/or rotational circumferential direction.

3. The rotating electrical machine according to claim 1, wherein when the radial core is joined and fixed after winding of the radial core, the “m” junction portions are subjected to either one of welding process, adhesion process or resin molding process, or combination thereof.

4. The rotating electrical machine according to claim 1, wherein the compacted powder forming the radial core is subjected to at least one of resin coating treatment and resin impregnation treatment, or both the treatments.

5. The rotating electrical machine according to claim 1, wherein the rotating electrical machine is an inverted rotor type rotating electrical machine, in which when the winding is wound around the radial core and then integrated and fixed, a cylindrical member is inserted into the integrated radial core and fitted to an inner periphery of the integrated radial core in a manner of providing a concentric structure.

6. A rotating electrical machine of radial-gap inner rotor type in which a radial core, having number of winding slots of “m”, is constructed as an integral compacting type by the compacted powder or as a split compacting type with the compacted powder, wherein a portion concentrically protruding in an axial direction in a side view of the radial core as a concentric guide for ensuring an air gap between the stator and a rotor, and the protruded portion is engaged with front and back brackets, in which the “m” is integer number in a range of 4 to 12 (not less than 4 and not more than 12).

7. The rotating electrical machine according to claim 6, wherein the radial core has a thickness in an axial direction of the winding portion so as to become thinner toward outward from a central portion thereof.

8. The rotating electrical machine according to claim 6, wherein the radial core is provided with a groove or a hole at outer peripheral portion of the central portion thereof, and the radial core is fixed to the brackets by interposing metal material other than the compacted powder in the groove or hole.

9. The rotating electrical machine according to claim 6, wherein when the radial core is constructed by “m” split compacting and the radial core is integrated with and fixed to the winding after the winding process, a junction portion of an outer peripheral portion at the integrating process is coupled by means of welding.

10. The rotating electrical machine according to claim 6, wherein the compacted powder forming the radial core is subjected to at least one of resin coating treatment and resin impregnation treatment, or both the treatments.
